(19) United States
(12) Patent Application Publication
(10) Pub. No.: US 2009/0321429 A1
(43) Pub. Date: Dec. 31, 2009

(54) Microwave oven

(76) Inventors: Roderick A. Hyde, Redmond, WA (US); Muriel Y. Ishikawa, Livermore, CA (US); Edward K.Y. Jung, Bellevue, WA (US); Nathan P. Myhrvold, Medina, WA (US); Clarence T. Tegreene, Bellevue, WA (US); Lowell L. Wood, JR., Bellevue, WA (US)

Correspondence Address: Constellation Law Group, PLLC, P.O. Box 220, Tracyton, WA, 98393, US

(21) Appl. No.: 12/217,139

(22) Filed: Jun. 30, 2008

(51) Int. Cl. H05B 6/68; H05B 6/50

(52) U.S. Cl. 219/710; 426/523; 219/704; 219/716; 219/720; 219/714

(57) ABSTRACT

Generally and not exclusively, a microwave cooking oven to cook food in a microwave chamber (e.g., a cooking chamber) includes a microwave power source, and a microwave control unit. The control unit includes a microwave detector to detect the microwave power in the cooking chamber, and a control circuit to determine the food optical density or food temperature, based on the microwave power being absorbed by the food. The control circuit determines the microwave power being absorbed based on the difference between the power emitted into the cooking chamber and the power detected within the cooking chamber. In one illustrative embodiment, microwave power is emitted by multiple ports from different directions, and the microwave power absorbed by the food along these different directions is measured. The control circuit then determines the optical density or temperature of the food along each direction. In one illustrative embodiment, the control circuit directs the power source to emit microwave power based on the determined power being absorbed by the food.

### TECHNICAL FIELD

This invention relates generally to a microwave oven, and more particularly but not exclusively to an apparatus and method to estimate the optical depth of an item exposed to radiation in the microwave oven, and to control the power radiated by the microwave oven, based on the estimated optical depth.

### BACKGROUND

A microwave oven heats objects, such as food. It may be surmised that a person operating the microwave oven does not know the object temperature or cooking state, and controls the microwave oven by guessing at the temperature or cooking state, or by operating the microwave power arbitrarily.

### SUMMARY

Generally and not exclusively, a microwave oven to heat objects in a cooking chamber includes a microwave power source, and a microwave control unit. In one illustrative embodiment, the control unit includes a microwave detector to detect the microwave power in the cooking chamber, and a control circuit to determine the object optical density or temperature based on the microwave power being absorbed by the object. In one aspect, the control circuit determines the microwave power being absorbed based at least partially on the difference between the power emitted into the cooking chamber and the power detected within the cooking chamber. In one illustrative embodiment, microwave power is emitted by multiple ports from different directions, and the microwave power absorbed by the object along these different directions is measured. The control circuit then determines the optical density or temperature of the object in each direction. In one illustrative embodiment, the control circuit directs the power source to emit microwave power based on the determined power being absorbed by the object. In one application, the object is one or more items of food. In another approach, the object is an inanimate object for heating, such as a thermal mass for therapeutic application.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 is a block diagram of an embodiment of a microwave oven showing a cooking chamber, a microwave source, and a control circuit having a radiation detector, and a control circuit.

FIG. 2 is a front-view diagram of an embodiment of a microwave oven structure showing a chamber encompassing a food, a microwave source, a radiation detector, a microwave user interface, and a control circuit coupled to the microwave source, a control unit having a radiation detector and a control circuit, and a microwave user interface.

FIG. 3 is a front-view diagram of an embodiment of a microwave oven showing paired radiation emitters and detectors.

FIG. 4 is a front-view pictorial representation of an embodiment of a microwave oven showing valved microwave transmission system coupled to each microwave emitter port.

FIG. 5 is a block diagram of one embodiment of a microwave oven control unit.

FIG. 6 is a flow chart of one embodiment of a method of heating objects in a microwave cooking chamber.

FIG. 7 is a flow chart of one embodiment of a method of heating objects in a microwave cooking chamber having multiple microwave emitter ports.

### DETAILED DESCRIPTION

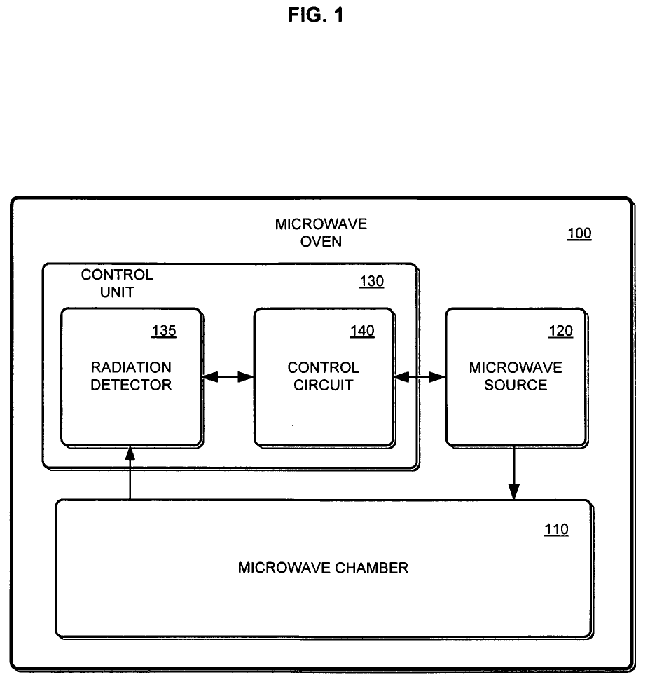

Referring to FIG. 1, there is shown a block diagram of an embodiment of a microwave oven 100. The microwave oven 100 includes a microwave chamber 110 (e.g., a cooking chamber) to enclose an object to be heated by the microwave oven 100. While the exemplary embodiment relates to a food object and the central enclosure is referred to as a microwave chamber 110, this is only exemplary. In other applications, the object may be water to be heated, an item to be dried, an inanimate thermal mass that may be applied as a therapeutic heat pack, an item to store and controllably release heat or other energy, such as a handwarmer, or any other item for which such heating may be desired. Additionally, the approaches herein may be applied to situations where increasing the item's temperature is not an objective of or not the only objective of applying microwave energy. For example, such microwave application may be desirable to initiate chemical or other interactions, increase plasticity, induce chemical breakdown, or produce other reactions in the item in the chamber 100.

The microwave chamber 110 is operationally coupled to both a microwave source 120, and to a radiation detector 135. The microwave source 120 and the radiation detector 135 are each operationally coupled to a control circuit 140. The radiation detector 135 and control circuit 140 are components of a control unit 130. The microwave source 120 is configured to emit microwave radiation into the microwave chamber 110 from at least one position, and to emit the microwave radiation into the microwave chamber 110 in response to a control signal from the control circuit 140. The radiation detector 135 is configured to detect the microwave power within the microwave chamber 110 from at least one position, and to provide an indication of the detected microwave power to the control circuit 140. In one implementation, the radiation detector 135 is a microwave detector.

The microwave source 120 in operation transforms input electrical power into microwave power that is emitted into the microwave chamber 110. In one implementation, the microwave source 120 includes a power supply, a microwave generator, and a microwave transmission system. The power supply is configured to draw electrical power from a line, convert the electrical power into a form required by the microwave generator, and to provide the converted electrical power to the microwave generator. The microwave generator, typically a magnetron, generates microwaves from the provided electrical power. The microwave transmission system transfers the generated microwaves into the microwave chamber 110. The transmission system may include a device, typically a microwave stirrer, to cause the object to be heated more uniformly by distributing the microwave radiation emitted into the microwave chamber 110 more uniformly, and reducing standing waves within the microwave chamber 110. In one implementation, a rotatable support for the object is disposed within the microwave chamber 110 in place of, or in addition to, the stirrer within the microwave chamber 110. In one implementation, a load-bearing belt moves through a conveyorized oven of one or more cavities. In one implementation, the power generated by the microwave generator is controlled by adjusting the magnitude of the voltage, or the duty cycle of the voltage, provided to the microwave generator. The microwave source 120 is operationally coupled to the control circuit 140. In one implementation, the control circuit 140 provides to the microwave source a signal indicating the power the microwave source should emit into the microwave chamber 110. A radiation control mechanism (not shown) of the microwave source 120 is configured to control the power emitted by the microwave source 120 as indicated by the control circuit 140. In one implementation, the microwave source 120 is configured to provide to the control circuit 140 a signal indicating the power of the microwave power emitted into the microwave chamber 110 by the microwave source 120.

The radiation detector 135 in this implementation is configured to transform detected microwave power in the microwave chamber 110 into a radiation detector signal indicative of the microwave power within the microwave chamber 110. Broadly, in one implementation the radiation detector 135 includes a receiving element to transduce sensed radiation power, here microwave power, into an electrical signal, and a signal conditioning element to provide an electrical signal to the control circuit 140 indicative of the sensed microwave power. In one implementation, the receiving element includes a diode detector to transduce the radiation power. In one implementation, the signal conditioning element is a component of the control circuit 140.

The control circuit 140 is configured to determine the extent to which the object is heated/is cooked based on the microwave power that the object is absorbing/has absorbed. Before describing the structure of the control circuit 140 in greater detail, a framework for relating the extent to which the object is heated to absorbed microwave power is described.

Microwave power may be heuristically understood to increase the temperature of irradiated objects as the microwave power is absorbed by the objects, by polar and/or ionic interaction of the objects with the microwave power. This interaction results in a movement of the power absorbing molecules and/or atoms in the object to generate frictional heat. For food, the most significant absorbing food constituent is usually water, whose molecules are excited by polar interaction to align with the applied oscillating microwave field. This alignment action results in collisions with neighbors, generating frictionally produced thermal energy.

An analytical and empirical functional relationship has been posited between the heat absorbed by a material at a given temperature, and the microwave power absorbed by the material. The microwave power absorbed by the material is posited to be related to its optical depth (or optical thickness). The functional relationship is posited to be approximately linear for small optical depths. For example, for a plane-parallel sample geometry with thickness t and surface area A, the posited relationship can be shown analytically by the formula

P=I*A*F*(1−e⁻^{^{*t}}) (1)

where P is the absorbed power of the material,
I is the incident irradiating power density,
F is an edge reflection correction factor,
α is the sample radiation absorptivity, and
* is the multiplication operator.

Similar relationships can be determined for samples with arbitrary shape (non-plane-parallel sample geometry), but the foregoing relationship can generally be employed as an approximation sufficient for engineering purposes. The power P absorbed by the sample will generally be proportional to 1−e^{-αt}. Material optical depth is indicated by αt. For a sufficiently small optical depth αt, 1−e⁻^{_{α}}^{t} is approximately αt, and the absorbed power of the material at a given temperature is approximately linear with respect to optical depth. For sufficiently small optical depths, the absorbed power is proportional to the incident irradiating power density, the absorbing volume, and the absorptivity α, even for non-plane-parallel geometries.

An analytical and empirical inverse relationship has been posited to exist between a material's absorptivity (and hence its optical depth for a given configuration) and its temperature at a given incident microwave power. For food, the functional relationship is posited to be approximately inversely linear over the range of liquid food states. Absorptivity is empirically and analytically related to sample load factor (loss tangent δ). This relationship is moreover posited to be approximately linear for most foods at temperatures of interest. Load factor is defined as ε″/ε′, where ε′ is the real part of a material's dielectric constant (known also as the permittivity) and ε″ is the imaginary part of the material's dielectric constant (known also as the dielectric loss factor). Because ∝=(2πε″)/(λε′^{0.5}) where λ is the free space wavelength of the absorbed microwave radiation, the load factor therefore varies approximately linearly with optical depth. It is understood that there is an inverse functional relationship between load factor and temperature for incident radiation over a range of liquid food states, and that this relationship is moreover approximately an inverse linear relationship.

Thus, it is posited that, as a food cooks, or an object heats, in a microwave oven, the microwave optical depth (or load factor) of the food decreases, and the power absorbed by the food decreases. Relative changes in optical depth may be measured by measuring the relative power absorbed by the food. There is posited to be a relationship between the power detected by the radiation detector 135 and the power absorbed by the food that can be roughly described in the following equation:

P_{ABSORBED}=K₁*(P_{MSOURCE}−P_{MDETECTOR}) (2)

where P_{ABSORBED} is the power absorbed by the food
P_{MDETECTOR} is the power in the microwave chamber 110 sensed by the radiation detector 135,
P_{MSOURCE} is the power emitted into the microwave chamber 110 by the microwave source 120, and
K₁ is a constant accounting for effects such as other microwave chamber absorbers.

In view of the foregoing, and using equation (1) above, the optical depth may be expressed as:

αt=−1n(1−(P_{ABSORBED}/K2)) where K₂ is a constant involving the incident power and reflection effects. In the plane-parallel configuration of Equation 1, K₂=I A F. (3)

Recall that above it was stated that “material optical depth is indicated by αt.” Thus, it is posited that, by knowing the microwave power in the microwave chamber that is generally sensed by the radiation detector 135, and the power emitted into the microwave chamber 110, the power absorbed by the food can be determined, and hence the microwave optical depth—or αt—of the food in the microwave oven 100 can be estimated. Utilizing the posited inverse relationship between food temperature and optical depth, the temperature of the food and/or the extent to which the food is cooked can therefore be at least approximately determined/inferred from that estimated optical depth. In one implementation, it is posited that the relationship between optical depth and temperature may be known by consultation of a look-up table, where the look-up table contains the results of empirical trials which correlate optical depth and temperature for defined food substances. An example of such a look-up table entry might state that a ¼ lb. beef pattie of 7% fat having an inferred optical depth of N millimeters would typically indicate 90 degrees Fahrenheit and/or would typically indicate that the ¼ lb. beef pattie has been cooked to “rare”. Once again, although the example provided here relates to food objects and cooking, other objects may be heated according to this approach.

The control circuit 140 determines the extent to which the food is cooked as a function of the microwave power the food sample is inferred to be absorbing/has absorbed (e.g., via a processor programmed to carry out Equation 2, above). In one implementation, the microwave power that the food is absorbing is determined by the control circuit 140 from the difference between the microwave power emitted by the microwave source 120 into the microwave chamber 110, and the microwave power in the microwave chamber 110. The microwave power emitted by the microwave source 120 into the microwave chamber 110 is indicated to the control circuit 140 by a sensing of the microwave source 120, such as the voltage or the duty cycle of the microwave source power supply. The microwave power in the microwave chamber 110 is indicated to the control circuit 140 by the microwave power sensed by the radiation detector 135 indicated by the radiation detector signal. In one implementation, the indicated microwave power emitted by the microwave source 120 into the microwave chamber 110 and/or the indicated microwave power in the microwave chamber 110, are adjusted for the particular characteristics of the microwave oven 100.

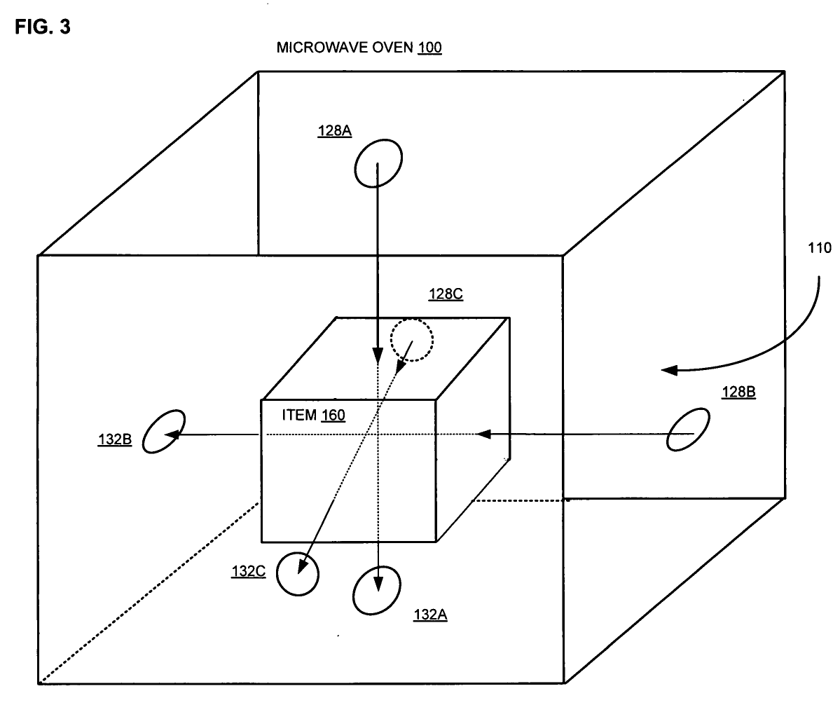

In one implementation, as more fully described with reference to FIG. 3 below, the microwave oven 100 has multiple microwave emitter ports and multiple radiation detector sensor ports disposed within the microwave chamber 110. Each microwave emitter port is paired with a radiation detector port configured to measure the microwave power emitted by the emitter port that has been transmitted through, i.e. not absorbed by, the food. In one implementation, an emitter port and its paired sensor port face each other, disposed on different sides of the food, such that in operation the sensor port measures the microwave power that is emitted by the paired emitter port that has not been absorbed by the intersecting food. The control circuit is configured to then approximately determine the optical depth of the food along the beam, or the axis formed by each pair of emitter and detector ports.

In one implementation, the control circuit 140 is configured to determine the extent to which the food is cooked for a specific food type, because optical depth (or loss tangent or dielectric characteristic) is a function of food type. In one implementation, the food type is assumed. For instance, in many applications microwave absorption is predominantly accounted for by the food's water content, or the food's optical depth is close enough to the optical depth of water so that the food type may be assumed to be water. In one implementation, food type is input to the control circuit 140 by an operator via a user interface (not shown) of the microwave oven 100.

For instance, in one implementation a user may select a food type (or food) from a selection menu of the user interface. Illustrative embodiments include a vegetable (such as broccoli), a salted meat (such as ham), a water and vegetable oil combination food (such as cake), and a non-salted meat (such as chuck roast). Vegetables are predominantly water so they may be treated as having an optical depth similar to water, salted meats contain sodium and chloride ions and may be treated as having a greater optical depth than non-ionized water, vegetable oil and water may have a distinct optical depth because vegetable oil absorbs microwave power due to the polar interaction of its molecules, and non-salted meat may have an optical depth similar to that of water.

In one implementation, the control circuit 140 is configured to estimate the food type by sensing the food optical depth at start-up based on a given food geometry and at an assumed temperature. In one implementation, control circuit 140 includes a library of food types and their optical depths at assumed temperatures for a given geometry, which is searched to determine the food type to be cooked. In one implementation, the control circuit 140 is configured to determine the extent to which food is cooked at a given moment based on the change in absorbed microwave power between start-up and the given moment where the start-up temperature is assumed.

In some implementations, the start-up temperature of the food is assumed to be a default temperature. In one implementation, the default start-up temperature is assumed to be an approximate lower range liquefaction temperature of water, e.g. 0° Celsius. In one implementation, the default start-up temperature is assumed to be an approximate refrigerated temperature, e.g. 6° Celsius. In one implementation, the default start-up temperature is assumed to be an approximate room temperature, e.g. 19° Celsius. In one implementation, start-up temperature is input to the control circuit 140 by an operator via the user interface (not shown) of the microwave oven 100. For instance, in one implementation a user may select a start-up temperature food type from a displayed selection menu of start-up temperature or start-up temperature categories. In another implementation, the user may select the start-up temperature via an input device of the user interface. In one implementation, the control circuit 140 is configured to estimate the starting temperature based upon sensing the food optical depth at start-up, based on a given food geometry and based upon an assumed (or user entered) food type.

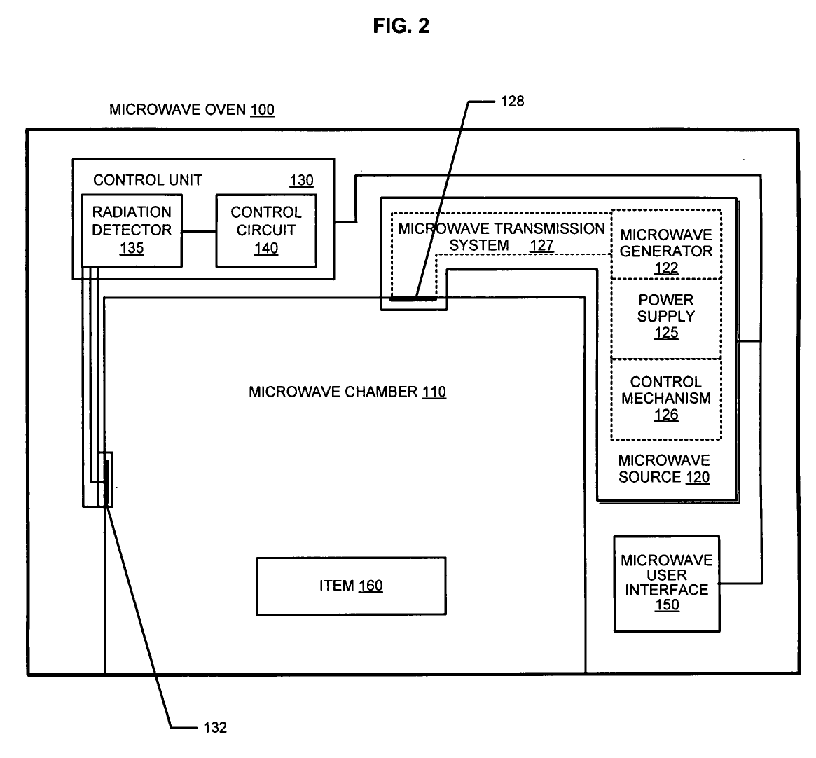

Turning now to FIG. 2, there is shown an illustrative front view embodiment of a microwave oven 100. The microwave oven 100 has a microwave chamber 110 for enclosing a food 160 to be cooked. The microwave oven 100 includes a microwave source 120 that has illustratively a microwave generator 122, an operationally coupled power supply 125, and an operationally coupled microwave transmission system 127, and at least one emitter port 128. The microwave source 120, via the microwave transmission system 127, is operationally coupled to the microwave chamber 110 through which the microwave power generated by the microwave generator 122 is emitted into the microwave chamber 110. The microwave source 120 has a radiation control mechanism 126 to control the microwave power emitted into the microwave chamber 110. In one illustrative implementation, the radiation control mechanism 126 is a unit that controls the power supplied by the power supply 125. In yet another illustrative implementation, the radiation control mechanism 126 is a radiation valve in the transmission system 127 that control the power being emitted to the microwave chamber 110.

The microwave oven 100 includes a control unit 130 comprising a radiation detector 135 and a control circuit 140. The radiation detector 135 is operationally coupled to the microwave chamber 110. The radiation detector 135 detects the radiation power in the microwave chamber 110 that in this implementation is microwave power, the radiation detector 135 therefore being a microwave detector. The radiation detector 135 includes at least one detector port 132. Although depicted here as somewhat projecting from the wall of the microwave chamber 110, in one implementation the detector port 132 may be embedded within the wall. The microwave oven 100 includes a control circuit 140 that determines the extent to which the food 160 is cooked. The control circuit 140 is operationally coupled to the microwave source 120 and to the radiation detector 135. The control circuit 140 receives from the microwave source 120 a signal indicating the microwave power emitted to the microwave chamber 110. The control circuit 140 receives from the radiation detector 135 a signal indicating the microwave power in the microwave chamber 110. The control circuit 140 is configured to determine the microwave power absorbed by the food 160 based on the microwave power emitted to the microwave chamber 110 and the microwave power in the microwave chamber 110. The control circuit 140 is configured to then determine the extent to which the food is cooked based on the determined microwave power absorbed by the food 160 such as described herein (e.g., using the inferred optical depth, food type, and look-up table to determine a food temperature or extent to which food is cooked). In one implementation, the control circuit 140 provides to the microwave source 120 a signal indicating the microwave power the microwave source 120 should emit to the microwave chamber 120 to cook the food 160 based on the control circuit 140 determined microwave power absorbed by the food 160. The control circuit 140 is configured to generate this signal to the microwave source 120 based on the signal received from the microwave source 120 indicating the microwave power transmitted to the microwave chamber 110 and the signal from the radiation detector 135 indicating the microwave power in the microwave chamber 110, and any inputs from the microwave user interface 150. In one implementation, the control mechanism 126 receives from the control circuit 140 the signal indicating the microwave power the microwave source 120 should emit to the microwave chamber 110 and configures microwave generator to emit microwave power as specified in the signal received from control circuit 140. In one implementation, the control circuit 140 determines that food cooking should cease and indicates that the microwave power should be zero. Although not shown in this figure, the microwave source 120 and/or the radiation detector 135 may include signal conditioning circuits for the signals provided to and/or received from the control circuit 140. The control circuit 140 is operationally coupled to the microwave user interface 150. The user interface is configured to receiver user inputs from an operator to the control circuit 140, and enunciate any user messages from the control circuit 140 to the operator. As described above with respect to FIG. 1, the microwave user interface 150 is configured to receive from the operator, and provide to the control circuit 140, data regarding food type, initial food temperature, and even the extent of cooking desired, such as target food temperature. The microwave user interface 150 is embodied with typical operator input mechanisms, such as selection buttons, menus, and icon or character keying mechanisms.

FIG. 3 portrays an illustrative embodiment of a microwave oven 100, having an emitter port 128A and a detector port 132A pair disposed within the microwave chamber 110. A paired emitter port and detector port are configured such that the emitter port beams radiation in the direction of its paired detector port, and the detector port can approximately measure that radiation. In operation, the form factor of microwave chamber 110 (and/or components therein) is such that food 160 is positioned between a paired emitter port and detector port so that the detector port can approximately measure the radiation that has not been absorbed by the food 160, but transmitted through/near the food 160. In one implementation, the microwave oven 100 has multiple emitter port and detector port pairs 128A-132A, 128B-132B, 128C-132C, each pair arranged so that the beam generated by an emitter port 128A, 128B, or 128C is orthogonal to each of the other beams. The beam intensities, measured relative to those taken with no load in the microwave chamber 110, give a basis for quantitatively estimating both the scattering and the absorption opacities of the food 160 along the axes of the aimed beams. Again, in one implementation, the radiation detector 135 (not shown) sends a signal indicating the radiation measured by the detector ports 132A 132B 132C to the control circuit 140 (not shown). The control circuit 140 determines the food optical depth along each beam to indicate how the food is cooking along each beam based on the absorbed radiation. By tomographic-like processing, data from a number of overlapping beams can be combined to indicate hot spots and/or cold spots along each beam. The control circuit 140 is configured to control the microwave power emission from each emitter port so that an emitter port generates power in response to the cooking of the food along its emitter beam.

In one implementation, the microwave oven 100 emits cooking microwave power into the microwave chamber 110 in addition to the radiation emitted by the emitters 128A, 128B, and/or 128C. In one implementation, the emitters 128A, 128B, and/or 128C are configured to emit radiation at a different frequency from the additional cooking microwave power, and the sensors 132A, 132B, and/or 132C are each configured to measure the frequency emitted by its paired emitter and not the cooking microwave frequency. In one implementation, the power emitted by the emitters 128A, 128B, and/or 128C is less than the cooking microwave power, accordingly the emitters are not configured to substantially cook the food, but instead to test the opacity of the food along its beam to determine how the food is cooking along the beam. In one implementation, the frequency emitted by the emitter ports 128A, 128B, and/or 128C are not microwave frequencies and may not have a substantial temperature raising consequence in the food, but are instead frequencies selected to direct the beam and penetrate the food with a measured optical depth. In one implementation, the emitters are laser emitters, and the emitted beam is lased radiation.

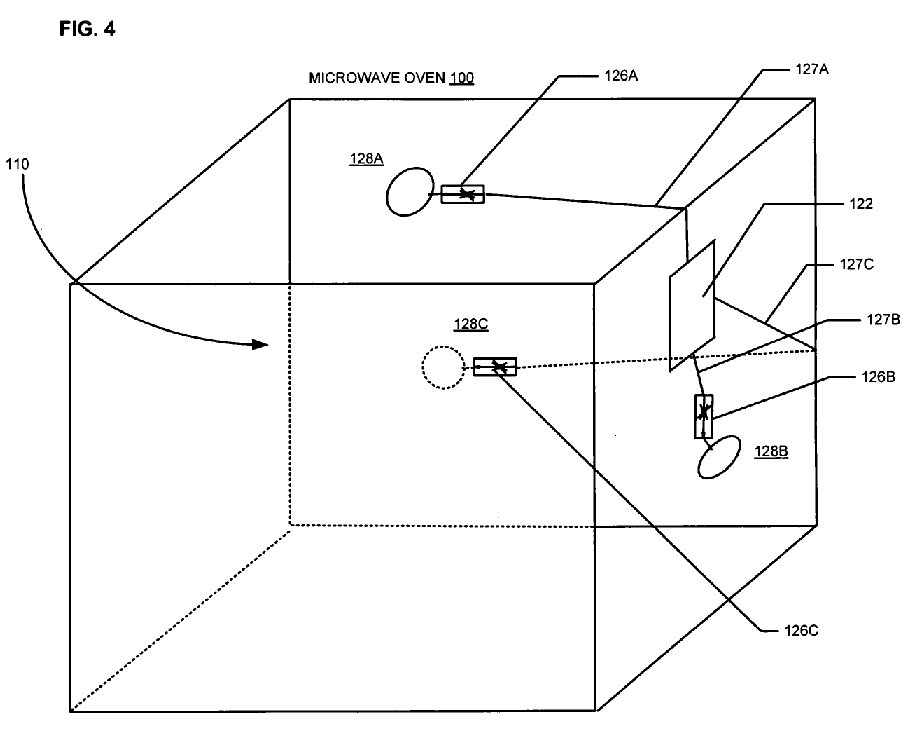

Referring to FIG. 4, an illustrative embodiment of a microwave oven 100 shows illustrative emitter ports 128A 128B 128C coupled to the microwave generator 122 by a respective microwave transmission system 127A 127B 127C. Each microwave transmission system 127A 127B 127C has a respective coupled radiation control mechanism 126A 126B 126C, the radiation control mechanisms 126A 126B 126C configured illustratively as radiation valves in the transmission system 127, to control the power transmitted by each emitter port 128A 128B 128C. Illustratively, in one implementation the radiation control mechanism 126A, 126B, and/or 126C is a thin (aluminum) metal vane deployed transversely off the walls of the transmission system, and capable of moving variably within its respective transmission system. Each radiation control mechanism 126A 126B 126C moves under the control of the control circuit 140. These vane-motions in operation serve to vector the radiation power within the microwave transmission system 127, by partly opening or closing each duct of the microwave transmission system 127 to the passage of radiation in response to the control circuit 140. The time-varying motion of these vanes may in one implementation additionally steer beams along additional axes in the oven microwave chamber 110, so as to execute a cooking program for a particular food being cooked by the control circuit 140.

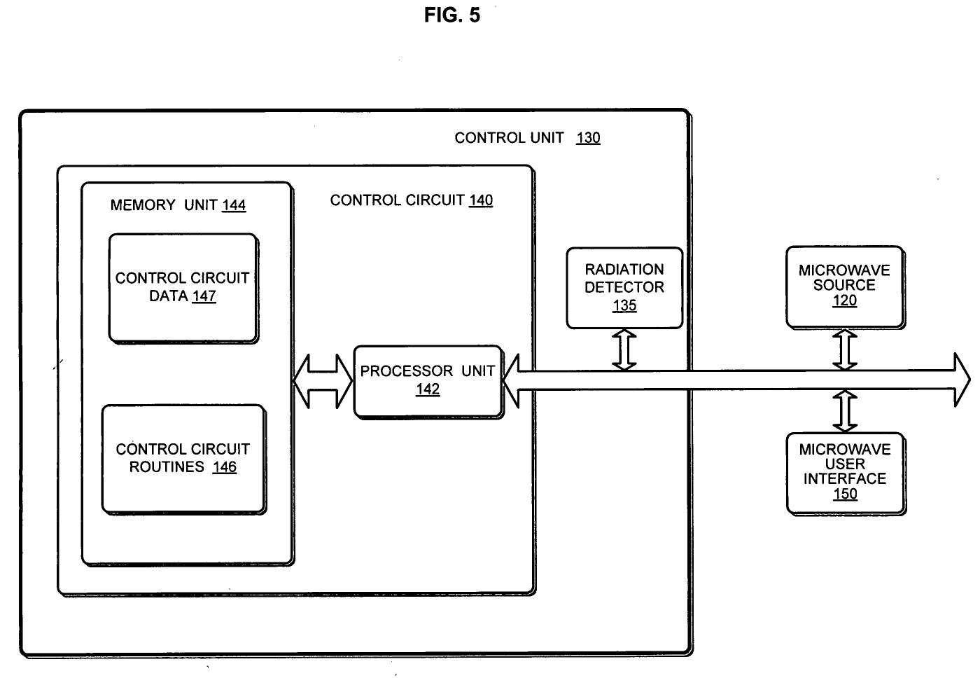

FIG. 5 illustrates one implementation of an exemplary control circuit 140. The illustrative embodiment includes a processor unit 142 and a memory unit 144 that together form at least a part of a programmed computer. The programmed computer in operation performs logical operations for the microwave oven. Although a programmed computer is described herein, it is specifically contemplated that fixed circuitry could perform the operations herein described. For instance, each mathematical and logical operation described can be implemented by finite state circuits specifically dedicated to the operation described, including retrieving data, logically manipulating that data, and comparing that data to other data.

The processor unit 142 includes one or more processors each capable of executing program instructions on data. The memory unit 144 may include a non-volatile memory that stores the control circuit 140 processing control circuit routines 146 and fixed control circuit data 147. The control circuit routines 146 when executed by the processor unit 142 cause the processor to perform the acts described herein. The processing routines and the fixed data stored on the non-volatile memory are sometimes termed firmware. Of course, even though the firmware is stored on the non-volatile memory, it may be executed from volatile memory after being written into the volatile memory. The non-volatile memory is useful for storing the control circuit routines 146 and the fixed control circuit data 147 when the memory unit is not powered. In operation of the microwave oven, at least a portion of the control circuit routines 146 and fixed control circuit data 147 may be loaded into a volatile memory for execution from the volatile memory. At least some of the firmware may be stored in the non-volatile memory in a compressed form, then decompressed during an operation of the control circuit, and then stored in the volatile memory in its decompressed form for execution. In one implementation, at least some of the firmware may also be executed from the non-volatile memory. The firmware may include an initialization routine for initializing the control circuit 140 during a startup or reset of the control circuit 140. The processor unit 142 is operationally coupled to the radiation detector 135, the microwave source 120, and in an implementation having a microwave user interface, the microwave user interface 150. The processor unit 142 sends to and receives from the microwave source 120 and the microwave user interface 150 signals across the coupling between the control circuit 140 and the microwave source 120 and microwave user interface 150, that include the signals described herein.

In one implementation, the control circuit routine 146 causes the control circuit 140 to read a signal, the signal indicating the microwave power in the microwave chamber 110, from the radiation detector 135; and to read a signal, the signal indicating the microwave power emitted by the microwave source 120, from the microwave source 120. In one implementation, the control circuit 140 determines the value of the microwave power being absorbed by the food based on these signals, by subtracting from the value of the indicated microwave power emitted by the microwave source the value of the indicated microwave power in the microwave chamber 110. As required for each application, each signal is adjusted for the specific characteristics of the microwave oven 100, the shape of the microwave chamber, the location and characteristics of the radiation detector 135, and the characteristics of the microwave chamber that may illustratively enable food absorption of already transmitted microwaves, to develop a more accurate estimate of the microwave power absorbed by the food.

In one implementation, the control circuit routine 146 causes the control circuit 140 to determine the degree that the food has cooked, or the temperature of the food, based on the microwave power being absorbed by the food (e.g., as described elsewhere herein). In one implementation, this determination is based on a default food volume and food type. In one implementation, the food volume and/or the food type is input to the control circuit 140 by an operator through the microwave user interface 150. In one implementation, a prior reading of the power absorbed by the food, such as at start-up, is measured, a default temperature or alternatively an operator input food temperature is acquired, and the food type is estimated based upon the food volume, the initial temperature, and the power being absorbed.

In one implementation, the control circuit routine 146 causes the control circuit 140 to read each of the separate radiation detection signals from multiple detection ports 132 indicating the microwave power transmitted through the food along a beam, and to read each of the signals from the microwave source 120 indicating the power emitted from each of the emitter ports 128. In one implementation, instead of an indication of the power emitted by each of the emitter ports coming from the microwave source 120, the power emitted from each of the emitter ports is determined by the control circuit 140 based upon the control circuit generated signal indicating the power to be emitted by the emitter ports. The control circuit 140 determines the optical depth or estimated food temperature along the beam, by subtracting the value of the indicated microwave power detected by a detector port from the power emitted by its paired emitter port. As required for each application, each signal is adjusted for the specific characteristics of the microwave oven 100, such as the efficiency and characteristics of emission along the beam, and the accuracy of the paired detector in sensing a beam.

In one implementation, the control circuit routine 146 causes the control circuit 140 to send a signal to the microwave source 120 to control the power of the microwave radiation radiated from the emitter ports, based on the determined microwave power absorbed by the food, the determined temperature of the food, or the determined optical depth or estimated temperature of the food along each beam of a paired emitter-detector port system. In one implementation, the signal indicates whether or not power should be emitted into the microwave chamber 110 or by an emitter port. In one implementation, the signal instead indicates the amount of power that should be emitted into the microwave chamber or emitter port. In one implementation, the indication of the signal is based on a target temperature of the food, derived from a database or according to a functional relationship. In one implementation, the indication of the signal is according to a recipe based on both time and optical depth (or temperature), including in one implementation a separate recipe for each region of the food (such as the inside or the edges), such that the signal is varied according to the recipe, including a separately varied signal for each emitter port.

In one implementation, the control circuit routine 146 causes the control circuit 140 to display on the microwave user interface 150 the temperature of the food, and/or a display of a temperature map of the food based on the food opacity (or temperature) sensed by each of the detector ports. In one implementation, the control circuit routine 146 causes the control circuit 140 to determine the cooking time remaining based on a recipe, food type, and current optical depth (or temperature), and displays the time on the microwave user interface 150.

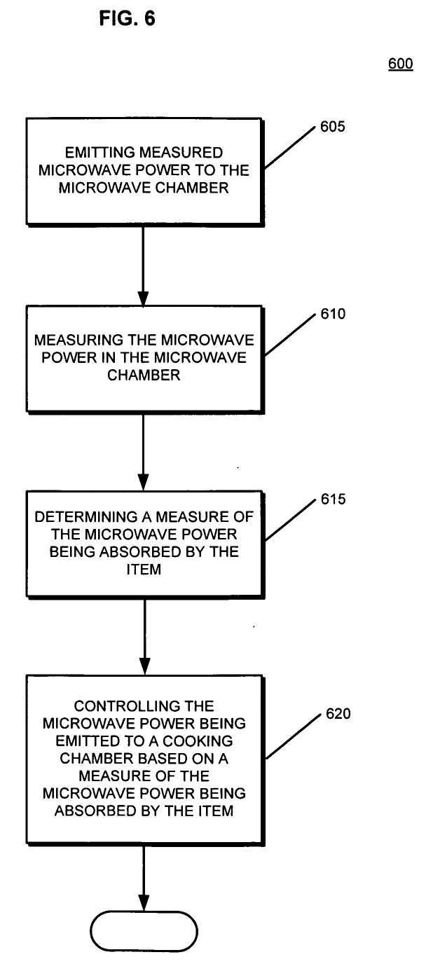

Referring now to FIG. 6, one exemplary method 600 of cooking food in a microwave chamber includes in block 605, emitting measured microwave power to the microwave chamber. In block 610, the microwave power in the microwave chamber is measured. In block 615, the microwave power being absorbed by the food is determined, based on the difference between the measured microwave power emitted into the microwave chamber (block 605) and the measured microwave power in the microwave chamber (block 610). In one implementation, the method 600 further includes a block 620 controlling the microwave power being emitted to a microwave chamber (e.g., a cooking chamber) based on a measure of the microwave power being absorbed by the item (block 615). In implementations, the determining is also based on the food type and the food volume (not shown). In one implementation, the controlling act is based on a recipe for the food or on a target temperature for the food. In one implementation, the method 600 further includes (not shown) determining the temperature of the food based on the microwave power absorbed by the food.

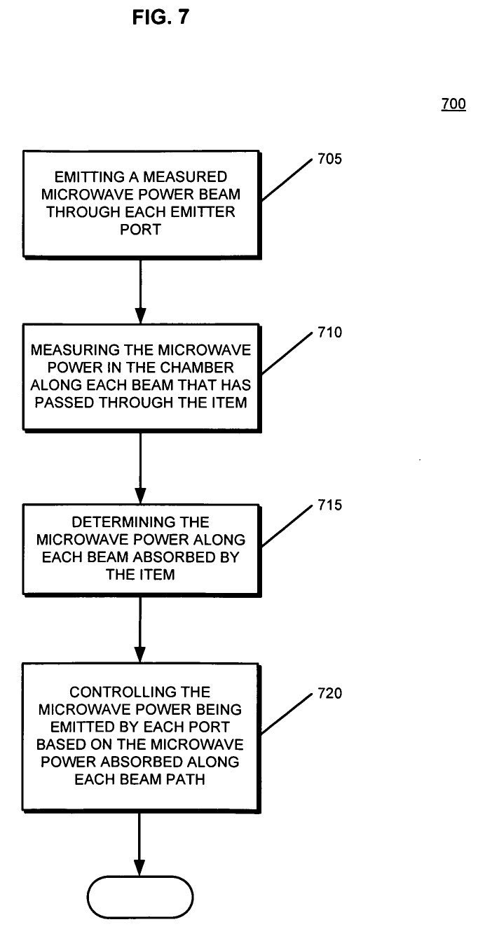

Referring now to FIG. 7, one exemplary method 700 of cooking food in a microwave chamber having multiple microwave emitter ports includes in block 705 emitting a measured microwave power beam through each emitter port, each port positioned to emit a separate microwave power beam to a different side of the food. In block 710, the microwave power in the microwave chamber is measured along each beam after it has been transmitted through the food. In block 715, the microwave power absorbed along each beam is determined based on the difference between the measured microwave power emitted by each beam into the microwave chamber and the measured microwave power along each beam after it has been transmitted through the food. In block 720, the microwave power being emitted by each emitter port is controlled based on the microwave power being absorbed along each beam. In one implementation, the microwave power emitted by each emitter port is controlled based on a recipe for the food along each beam (not shown). In one implementation, the microwave power emitted by each emitter port is controlled based on a target temperature for the food along each beam (not shown).

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory.

Further, implementation of at least part of a system for performing a method in one territory does not preclude use of the system in another territory.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. A method of heating an item in a microwave chamber comprising the following acts:
emitting measured microwave power to the microwave chamber;
measuring the microwave power in the microwave chamber; and
determining a measure of the microwave power being absorbed by the item based on a numerical relationship between the measured microwave power emitted into the microwave chamber and the measured microwave power in the microwave chamber.

2. The method of claim 1 further comprising:
controlling the microwave power being emitted to a cooking chamber based on a measure of the microwave power being absorbed by the item.

3. (canceled)

4. The method of claim 2 wherein controlling is further based on at least one of a food type and/or a food volume.

5. The method of claim 2 wherein the controlling is further based on a recipe for a food.

6. The method of claim 2 wherein the controlling is further based on a target temperature for the item.

7. The method of claim 2 wherein the controlling is further based on at least one of an item type and an item volume.

8. The method of claim 1 further comprising:
determining a temperature of the item based on the microwave power being absorbed by the item.

9. The method of claim 8 wherein the determining a temperature of the item is further based on at least one of an item type and/or an item volume.

10. (canceled)

11. The method of claim 1 wherein emitting measured microwave power to the microwave chamber includes:
emitting a measured microwave power through each emitter port of multiple emitter ports each positioned to beam microwave power along a respective beam path to a different region on a side of the item.

12. The method of claim 11 wherein measuring the microwave power in the microwave chamber includes:
measuring the microwave power in a cooking chamber along a beam path at a location associated with a region on a side of the item.

13. The method of claim 1 wherein determining a measure of the microwave power being absorbed by the item includes:
determining a microwave power absorbed along a beam path based on a difference between a measured microwave power emitted by a beam into a cooking chamber and a measured microwave power along a beam path associated with a region on a side of the item.

14. (canceled)

15. The method of claim 13 further comprising:
controlling a microwave power being emitted by an emitter port based on a microwave power being absorbed along a beam path.

16. The method of claim 15 wherein the item is food and wherein controlling a microwave power being emitted by an emitter port further comprises:
controlling a microwave power being emitted by an emitter port in response to a recipe for the food.

17. The method of claim 15 wherein controlling a microwave power being emitted by an emitter port further comprises:
controlling a microwave power being emitted by an emitter port in response to a target temperature for food along each beam path.

18. An apparatus, comprising:
a microwave chamber;
a microwave source to emit microwave power into the microwave chamber; and
a control unit configured to determine an indicator of an approximate microwave power being absorbed by an item in the microwave chamber.

19. The apparatus of claim 18 wherein the control unit is further configured to provide a signal to the microwave source indicative of the microwave power the microwave source is to emit into the microwave chamber based at least in part on the approximate microwave power being absorbed by the item.

20. The apparatus of claim 19 wherein the control unit is further configured to determine the microwave power the microwave source is to emit according to a recipe.

21. The apparatus of claim 20 wherein the recipe is based on at least one of time and/or optical depth.

22. The apparatus of claim 19 wherein the microwave source is configured to adjust the microwave power emitted into a cooking chamber in accordance with the signal.

23. The apparatus of claim 18 wherein the control unit is further configured to determine the microwave power the microwave source is to emit according to a target temperature.

24. The apparatus of claim 18 wherein the control unit is further configured to provide a notification to at least one of a human operator or a user interface indicating the microwave power being absorbed by the food.

25. The apparatus of claim 18, further including:
a microwave detector configured to monitor the approximate microwave power in the microwave chamber, and to provide an indication of the monitored microwave power to the control unit.

26. The apparatus of claim 25 wherein the control unit includes a control circuit configured to determine a measure indicative of the approximate microwave power being absorbed by the item based at least in part on both the microwave power indicated to be emitted into the microwave chamber and the microwave power indicated to be in the microwave chamber.

27. The apparatus of claim 18 wherein the control unit is configured to determine an approximate food temperature based at least in part on the approximate microwave power absorbed by the item.

28. The apparatus of claim 27 wherein the control unit is further configured to determine the approximate food temperature based on a dielectric characteristic of the item and a volume of the item.

29. The apparatus of claim 28 wherein the control unit is further configured to provide a notification to at least one of a human operator or a user interface indicating the approximate food temperature.

30. The apparatus of claim 18 wherein the control unit is configured to determine an approximate temperature of the item based at least in part on the approximate microwave power absorbed by the item.

31. The apparatus of claim 30 wherein the control unit is further configured to determine the approximate item temperature based on a dielectric characteristic of the item and the volume of the item.

32. The apparatus of claim 31 wherein the dielectric characteristic of the item is a default value.

33. The apparatus of claim 31 wherein the control unit includes a memory containing a set of dielectric characteristics.

34. The apparatus of claim 31 wherein the control unit is configured to retrieve one or more dielectric characteristics in response to an identified item type.

35. The apparatus of claim 34 wherein the control unit is configured to receive the item type from a user.

36. The apparatus of claim 34 wherein the control unit is configured to identify the item type.

37. The apparatus of claim 34 wherein the control unit is responsive to indicia on the item to identify the item type.

38. The apparatus of claim 37 wherein the indicia are optically detectible.

39. The apparatus of claim 38 wherein the indicia are manmade.

40. The apparatus of claim 31 wherein the dielectric characteristic of the item is determined by the control unit based on the approximate microwave power absorbed by the item at a selected food temperature.

41. The apparatus of claim 40 wherein the control unit is configured to accept the selected food temperature as an input.

42. The apparatus of claim 40 wherein the control unit is configured to accept the selected food temperature as an operator input.

43. The apparatus of claim 28 wherein the volume of the item is assumed by the control unit.

44. The apparatus of claim 28 further including:
an optical detector, wherein the control unit is configured to determine the volume of the item responsive to the optical detector.

45. The apparatus of claim 28 further including:
a weight measuring device, wherein the control unit is configured to determine the volume of the item responsive to the weight measuring device.

46. The apparatus of claim 28 wherein the control unit is responsive to an operator input to determine the volume of the item.

47. A cooking apparatus comprising:
a cooking chamber;
a microwave source configured to emit microwave power into the cooking chamber; and
a control unit operative to approximately determine microwave optical depth of a food in the cooking chamber.

48. The apparatus of claim 47 wherein the control unit is further operative to determine an approximate temperature of the food based at least in part on the determined approximate microwave optical depth of the food.

49. The apparatus of claim 47 wherein the control unit further comprises:
a microwave detector positioned to measure the microwave radiation within the cooking chamber; and
a control circuit responsive to the microwave detector to determine the approximate optical depth of the food.

50. The apparatus of claim 49 wherein the control circuit is operative to compute the optical depth based at least in part on the difference between the measured microwave power within the cooking chamber, and the microwave power being emitted into the cooking chamber.

51. The apparatus of claim 47 wherein the microwave source includes at least one emitter port oriented to direct the microwave power into the cooking chamber.

52. The apparatus of claim 51 wherein the microwave source includes a plurality of emitter ports, each emitter port being aligned to approximately direct the microwave power to a respective side of the food.

53. (canceled)

54. The apparatus of claim 52 wherein the control unit comprises:
at least one detector port aligned to substantially detect the microwave power that passed through the food from a respectively associated emitter port; and
a control circuit configured to determine the microwave optical depth of a food based at least in part on a difference in power between the power emitted by the respectively associated emitter port and the detected microwave power that passed through the food.

55. The apparatus of claim 52 further including:
a plurality of detectors, each aligned to a detect radiation from a respectively associated emitter port, wherein the control unit is configured to determine the microwave optical depth of the food responsive to the detected radiation from at least one of the detectors.

56. The apparatus of claim 55 wherein the control unit is configured to determine the microwave optical depth of the food responsive to a composite of the detected radiation from at least two of the detectors.

57. The apparatus of claim 52 wherein the control unit includes at least one detector port aligned to substantially detect the microwave power that passed through the food from a respectively associated emitter port, and wherein the control unit is further configured to produce a control signal responsive to a detected microwave power.

58. The apparatus of claim 57 wherein the microwave source has a power output responsive to the control signal.

59. The apparatus of claim 57 wherein the control signal is a function of a recipe.

60. The apparatus of claim 59 wherein the control signal is further a function of at least one of a determined temperature or an optical depth.

61. The apparatus of claim 57 wherein the control signal is based on a target temperature.

62. The apparatus of claim 57 further comprising:
a radiation control mechanism to control an intensity of the microwave power beamed by an emitter port in response to the control signal.

63. The apparatus of claim 62 wherein said radiation control mechanism is a microwave transmission valve.

64. The apparatus of claim 63 wherein an emitter port is supplied with microwave power by a separate microwave generator, and said radiation control mechanism separately controls an output of the separate microwave generator.

65. A cooking apparatus comprising:
a cooking chamber;
a microwave source configured to emit microwave power into the cooking chamber;
at least one emitter port;
a radiation source configured to emit a beam of radiation into the cooking chamber through the at least one emitter port such that the radiation is at a different frequency than the microwave power emitted by the microwave source;
at least one detector port to detect approximately the beamed radiation, the at least one detector port positioned so that it detects approximately the radiation beamed by a separate one of one or more emitter ports after the beamed radiation has passed through a food positioned in the cooking chamber; and
a control unit configured to approximately determine the approximate optical depth of the food along each radiation beam based at least partially on radiation absorbed by the food.

66. The apparatus of claim 65 wherein the control unit is further configured to determine an approximate optical depth along a radiation beam based at least in part on both the power of the radiation beam emitted by an emitter port, and the power of the radiation beam absorbed by a detector port.

67. (canceled)
